(19) United States
(12) Patent Application Publication
(10) Pub. No.: US 2020/0359825 A1
(43) Pub. Date: Nov. 19, 2020

(54) BEVERAGE SELF-PROPELLING AND PRODUCTION SYSTEM

(71) Applicant: O-VIEW Technology Co., Ltd., New Taipei City (TW)

(72) Inventor: Chia-I PAN, New Taipei City (TW)

(21) Appl. No.: 16/875,596

(22) Filed: May 15, 2020

(30) Foreign Application Priority Data
May 16, 2019 (TW) 108116947

(51) Int. Cl. A47J 31/00; A47J 31/40; A47J 31/52; A47J 31/44; A47J 43/042

(52) U.S. Cl. CPC A47J 31/007; A47J 31/40; A47J 43/042; A47J 31/521; A47J 31/4425; A47J 31/525

(57) ABSTRACT

A beverage self-propelling and production system comprises a beverage production region, a self-propelled vehicle device and a server appliance wherein: the beverage production region has several beverage production workstations, several trajectory line objects and several sensor elements; the server appliance receiving at least a group of order messages drives the self-propelled vehicle device to move along the trajectory line objects and stop at different beverage production workstations, controls supplies of ingredients at the beverage production workstations, and depends on the order messages to change a move path of the self-propelled vehicle device for production and output of a beverage product after completion of the self-propelled vehicle device passing through different beverage production workstations in turn.

### BACKGROUND OF THE INVENTION

### 1. Field of the Invention

The present disclosure relates to a beverage self-propelling and production system, particular a system equipped with a self-propelled vehicle device which moves itself for fast production of beverages.

### 2. Description of Related Art

A shaker cup available in the market is produced according to an order of a customer who prefers the sweetness level (sugar-free, quarter sugar or regular sugar) and the amount of ice (ice-free, less ice or more ice), both of which are added into beverages correspondingly for mixing and shaking manually or in a machine and sealing at a sealing machine.

However, an owner of a beverage shop has to assign several salesclerks to deal with a customer's order based on the principle of division of labor. Moreover, the owner of a beverage ship will face increased personnel costs in an off season because of redundant salesclerks employed but probably lose customers in a peak season because of beverages wrongly prepared by fallible salesclerks in a hurry. Accordingly, how to control personnel costs is an issue which always perplexes an owner of a beverage shop at present.

Currently, the robot-based beverage production equipment has been developed but falls short of appropriate flexibility attributed to imperfect robot control and fails to produce several cups of beverages simultaneously. The present disclosure offers a preferable solution based on a self-propelled vehicle device to handle different orders for beverages in which preferred ingredients are added, match a distinct move path for possibility of producing several cups of beverages, and settle the problem in the prior art effectively.

### SUMMARY OF THE INVENTION

The present disclosure relates to a beverage self-propelling and production system comprising: a beverage production region with several beverage production workstations and several trajectory line objects wherein the trajectory line objects are arranged among the different beverage production workstations in which several move paths are created; a self-propelled vehicle device equipped with one or more cup holders, each of which carries a beverage cup thereon, and moving along the trajectory line objects; a server appliance communicating with several beverage production workstations as well as the self-propelled vehicle device and producing and sending one or more instructions through which a move path of the self-propelled vehicle device is controlled and the beverage production workstations are operated for production and output of a beverage product after completion of the self-propelled vehicle device passing through different beverage production workstations in turn.

In a preferred embodiment, each of the beverage production workstations is provided with an ingredient output appliance with which at least an ingredient, for example, ice, sugar, tea, milk or a combination thereof, is added into a beverage cup.

In a preferred embodiment, each of the beverage production workstations comprises an appliance listed as follows:

a positioner appliance with which a beverage cup is placed on a cup holder;

a sealing appliance with which a beverage cup is sealed; or

a shaker appliance with which a beverage product is shaken.

In a preferred embodiment, the beverage production region is provided with several sensor elements, each of which is installed on a beverage production workstation, on a trajectory line object, and/or between different trajectory line objects, interacts with the self-propelled vehicle device for mutual induction, and passes a position signal as well as a series number of the self-propelled vehicle device to the server appliance such that a current position of the self-propelled vehicle device is determined by the server appliance according to the series number transmitted from different sensor elements.

In a preferred embodiment, the sensor elements are operated based on the near field communications technology or the radio frequency identification technology.

In a preferred embodiment, the self-propelled vehicle device comprises a vehicle body, a printed circuit board installed on the vehicle body and a power supply unit: the vehicle body is provided with at least a wheel installed at each of both sides and electrically connected with a motor element by which the wheel is driven to rotate; the vehicle body is equipped with at least a supporting roller ball component at the bottom.

In a preferred embodiment, the printed circuit board is equipped with:

a central controller;
a power drive circuit component, which is electrically connected with the central controller and the motor element for driving the motor element;
a wireless communications circuit component, which is electrically connected with the central controller and used to receive a trajectory motion instruction from the server appliance and control a move path of the vehicle body based on the trajectory motion instruction;
a sensor circuit component, which is electrically connected with the central controller and used to detect the sensor element and send a series number of the self-propelled vehicle device to the detected sensor element from which the series number is transferred to the server appliance such that a current position of the self-propelled vehicle device is determined by the server appliance according to the series number transmitted by different sensor elements;
a tracking circuit component, which is electrically connected with the central controller and used to emit a tracking signal that may contact a plane for reflection of an optical signal wherein the tracking circuit component depends on intensity of the reflected optical signal to correct a move path of the vehicle body.

In a preferred embodiment, the cup holder further comprises a weight detection circuit component which is electrically connected with the central controller and used to detect the weight of a beverage cup and pass a signal for the detected weight to the server appliance through the wireless communications circuit component such that a beverage production workstation is operated by the server appliance controllably based on the received signal for the detected weight.

In a preferred embodiment, the power supply unit further comprises a power detection circuit component which is electrically connected with the central controller and used to detect power of the power supply unit and pass a signal for the detected power to the server appliance through the wireless communications circuit component.

In a preferred embodiment, the server appliance is equipped with a central control circuit component, a wireless transmission circuit component and an inductive receiver circuit component inside wherein the central control circuit component that is connected with the wireless transmission circuit component and the inductive receiver circuit component is able to navigate the self-propelled vehicle device to change a move path according to at least a group of order messages.

In a preferred embodiment, the central control circuit component of the server appliance produces and transmits one or more trajectory motion instructions with which a move path of the self-propelled vehicle device is changed.

In a preferred embodiment, the central control circuit component of the server appliance produces and transmits one or more station execution instructions with which a beverage production workstation is operated controllably.

### BRIEF DESCRIPTION OF THE DRAWINGS

FIG. 1 is a schematic view for overall architecture of a beverage self-propelling and production system.

FIG. 2 is a schematic view for architecture of a self-propelled vehicle device in a beverage self-propelling and production system.

FIG. 3 is a schematic view for architecture of a printed circuit board in a beverage self-propelling and production system.

FIG. 4 is a schematic view for architecture of a server appliance in a beverage self-propelling and production system.

FIG. 5A is a schematic top view for structure of a self-propelled vehicle device in a beverage self-propelling and production system.

FIG. 5B is a schematic bottom view for structure of a self-propelled vehicle device in a beverage self-propelling and production system.

FIG. 5C is a schematic view for structure of a self-propelled vehicle device on which a beverage cup is placed in a beverage self-propelling and production system.

FIG. 6A is a schematic view for a procedure to produce a single cup of beverages in a beverage self-propelling and production system.

FIG. 6B is a schematic view for a move path to produce a single cup of beverages in a beverage self-propelling and production system.

FIG. 6C is another schematic view for a move path to produce a single cup of beverages in a beverage self-propelling and production system.

FIG. 7A is a schematic view for a procedure to produce two cups of beverages in a beverage self-propelling and production system.

FIG. 7B is a schematic view for move paths to produce two cups of beverages in a beverage self-propelling and production system.

### DETAILED DESCRIPTION OF THE PREFERRED EMBODIMENTS

The technical contents, features and effects of a beverage self-propelling and production system are clearly explained in preferred embodiments and accompanying drawings as follows.

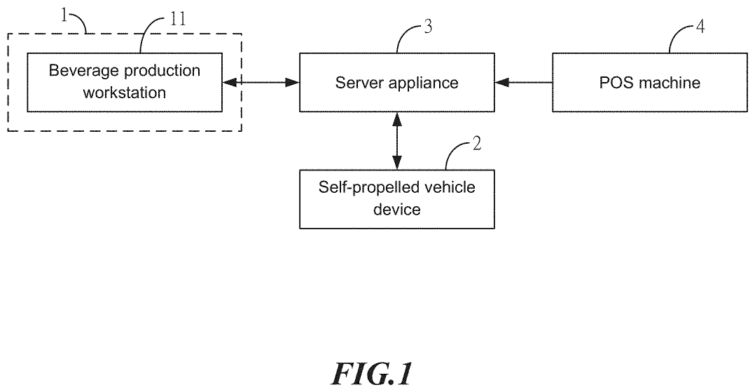

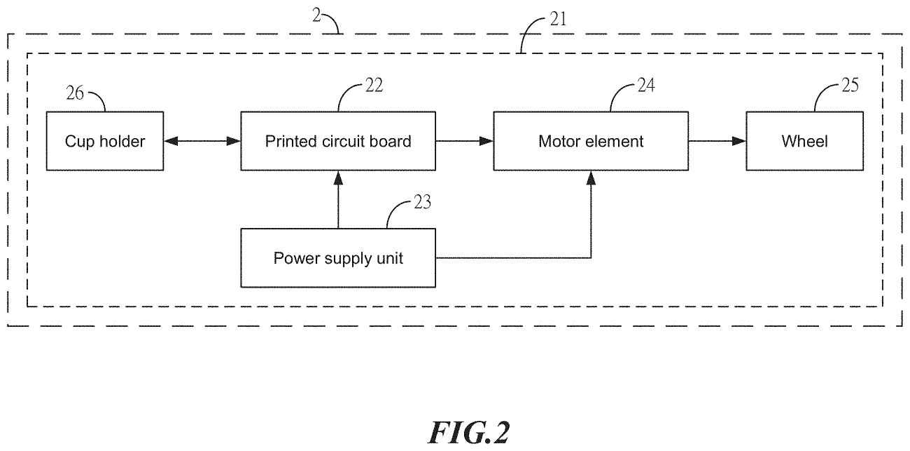

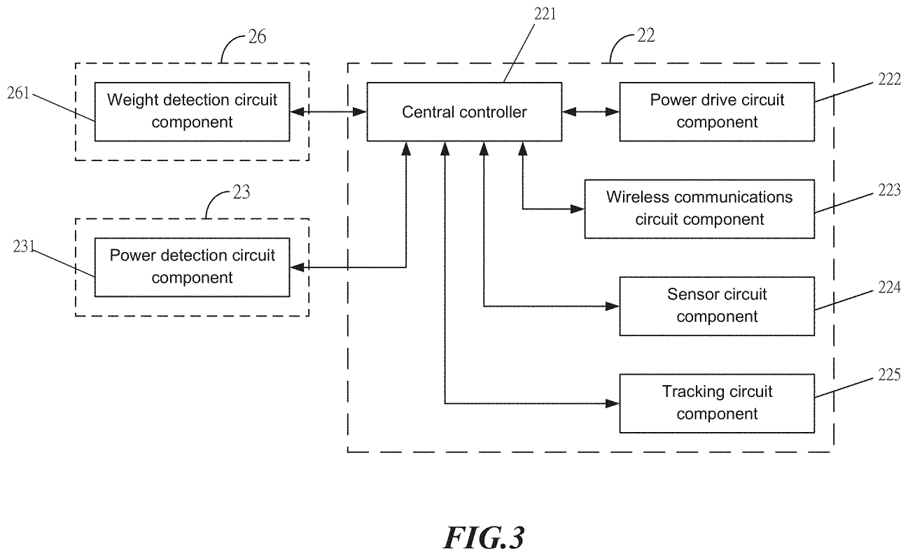

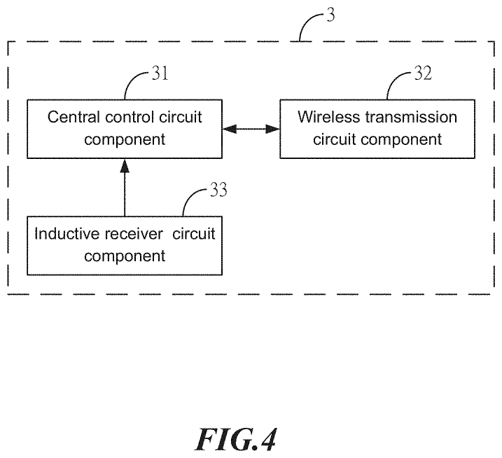

Referring to FIGS. 1, 2, 3, 4, 5A and 5B which are a schematic view for overall architecture of a beverage self-propelling and production system, a schematic view for architecture of a self-propelled vehicle device, a schematic view for architecture of a printed circuit board, a schematic view for architecture of a server appliance, and schematic top and bottom views for structure of a self-propelled vehicle device, respectively; as shown in figures, a beverage self-propelling and production system comprises a beverage production region 1, a self-propelled vehicle device 2 and a server appliance 3.

In a beverage self-propelling and production system, the beverage production region 1 comprises several beverage production workstations 11, several sensor elements and several trajectory line objects: the trajectory line objects are arranged among the different beverage production workstations 11 in which several move paths are created; the sensor elements, each of which is installed on a beverage production workstation 11 and/or between different trajectory line objects, are operated based on the near field communications technology or the radio frequency identification technology.

The self-propelled vehicle device 2 comprises a vehicle body 21, a printed circuit board 22 installed on the vehicle body 21, a power supply unit 23 and one or more cup holders 26: the vehicle body 21 is provided with at least a wheel 25 installed at each of both sides and electrically connected with a motor element 24 by which the wheel 25 is driven to rotate; the vehicle body 21 is equipped with at least a supporting roller ball component 27 at the bottom by which the self-propelled vehicle device 2 turns left or right.

The printed circuit board 22 carries a central controller 221, a power drive circuit component 222, a wireless communications circuit component 223, a sensor circuit component 224 and a tracking circuit component 225 and the self-propelled vehicle device 2 further comprises a power detection circuit component 231 and a weight detection circuit component 261 wherein all component have distinct functions as follows:
(1) The power drive circuit component 222 is used to drive the motor element 24;
(2) The wireless communications circuit component 223 is used to receive a trajectory motion instruction from the server appliance and control a move path of the vehicle body based on the trajectory motion instruction wherein the wireless communications circuit component 223 is a Bluetooth-based or WiFi-based component;
(3) The sensor circuit component 224 that has detected a sensor element sends a series number of the self-propelled vehicle device 2 to the sensor element which further passes the series number to the server appliance 3 such that a current position of the self-propelled vehicle device 2 is determined by the server appliance 3 according to the series number transmitted from different sensor elements;
(4) The tracking circuit component 225 installed on the printed circuit board 22 at the bottom and each of three tracking circuit components 225 in the embodiment emits a tracking signal that may contact a plane for reflection of an optical signal wherein the tracking circuit component 225 referring to intensity of the reflected optical signal is capable of correcting a move path of the vehicle body 21 and provided with at least an infrared emitting element from which a tracking signal (that is, an infrared signal) is sent;
(5) The power detection circuit component 231 installed inside the power supply unit 23 is able to detect power of the power supply unit 23 and pass a signal for the detected power to the server appliance 3 through the wireless communications circuit component 223;
(6) The weight detection circuit component 261 installed under the cup holder 26 is able to detect the weight of a beverage cup and pass a signal for the detected weight to the server appliance 3 through the wireless communications circuit component 223 such that the beverage production workstation 11 is operated by the server appliance 3 controllably based on the received signal for the detected weight.

The server appliance 3 communicating with several beverage production workstations 11 and the self-propelled vehicle device 2 is able to produce and send one or more instructions with which the self-propelled vehicle device 2 runs along a move path controllably and the beverage production workstations 11 are operated for production and output of a beverage product after completion of the self-propelled vehicle device 2 passing through different beverage production workstations 11 in turn.

The server appliance 3 is equipped with a central control circuit component 31, a wireless transmission circuit component 32 and an inductive receiver circuit component 33 inside wherein the central control circuit component 31 that is connected with the wireless transmission circuit component 32 and the inductive receiver circuit component 33 is able to navigate the self-propelled vehicle device 2 to change a move path according to at least a group of order messages and the wireless transmission circuit component 32 is able to transmit an instruction according to the Bluetooth or WiFi technology.

The server appliance 3 sends distinct control instructions explained hereinafter:
(1) One or more trajectory motion instructions produced and transmitted by the central control circuit component 31: each of more than one sensor elements installed among different trajectory line objects detects and passes a position signal to the inductive receiver circuit component 33 of the server appliance 3; the trajectory motion instruction(s) produced by the server appliance 3 based on the position signal received is (are) transmitted through the wireless transmission circuit component 32 for any change of a move path of the self-propelled vehicle device 2.
(2) One or more station execution instructions produced and transmitted by the central control circuit component 31: each of more than one sensor elements installed on beverage production workstations 11 detects and passes a position signal to the inductive receiver circuit component 33 of the server appliance 3; the station execution instruction(s) produced by the server appliance 3 based on the position signal received is (are) transmitted through the wireless transmission circuit component 32 for running the beverage production workstation 11 controllably.

Furthermore, the server appliance 3 links a POS machine 4 from which at least a group of order messages are created.

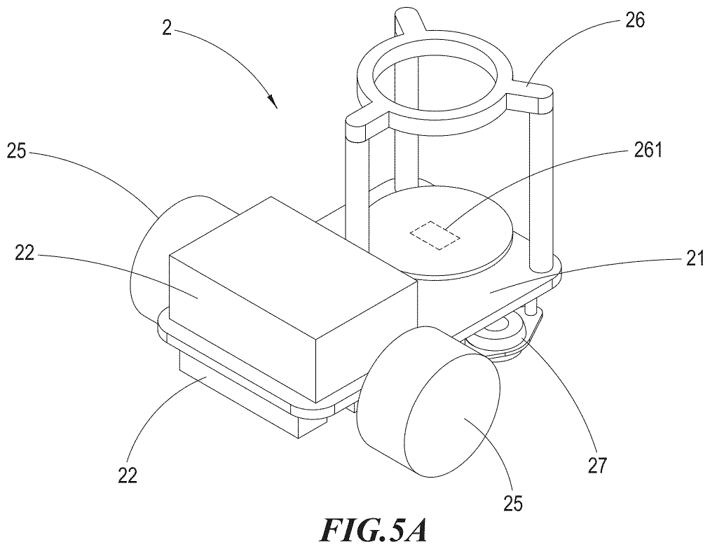

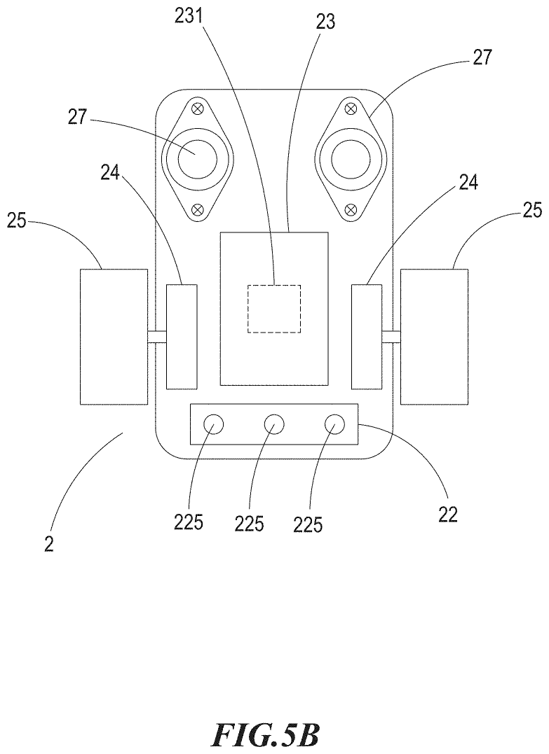

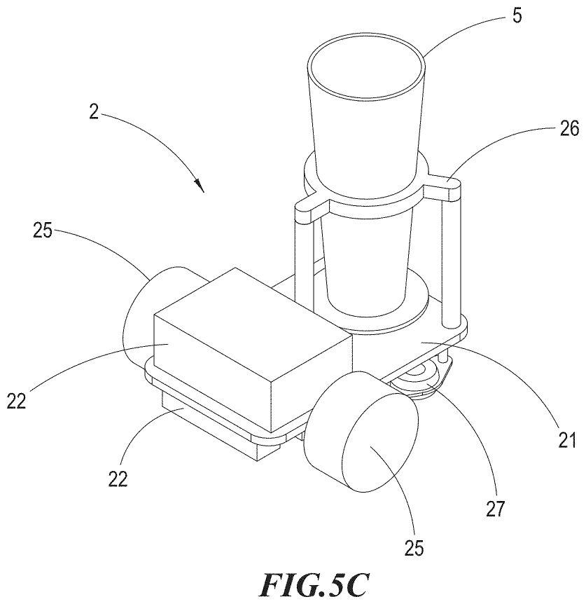

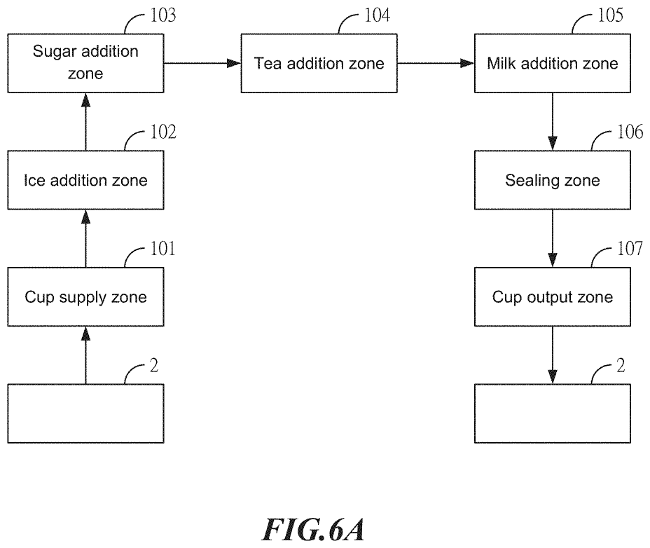

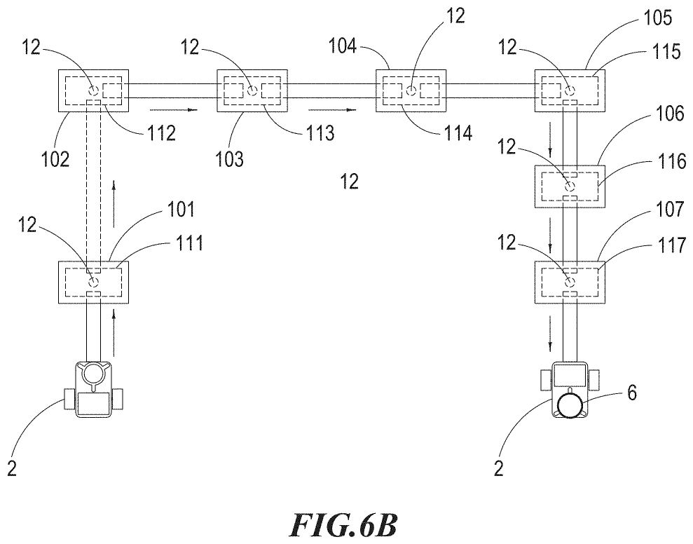

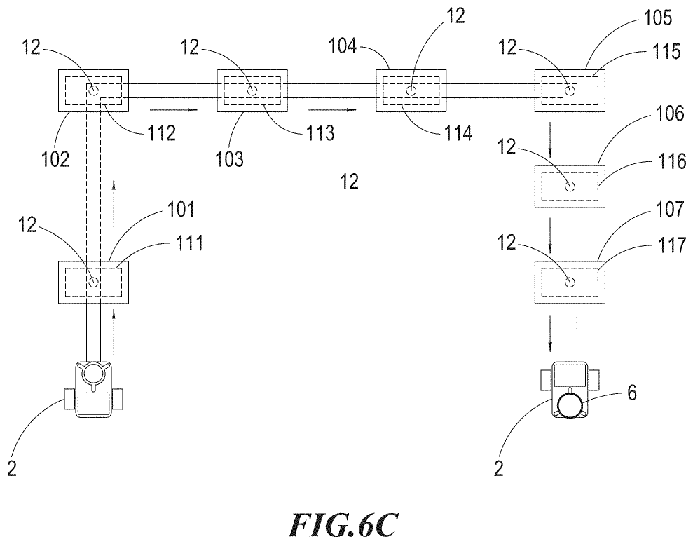

As shown in FIG. 5A to FIG. 5C for a perspective structure of the self-propelled vehicle device 2 in service, an empty beverage cup 5 is first placed on the cup holder 26. For production of beverages in FIGS. 6A and 6B, the beverage production region 1 consists of a cup supply zone 101 with a cup supply workstation 111, an ice addition zone 102 with an ice addition workstation 112, a sugar addition zone 103 with a sugar addition workstation 113, a tea addition zone 104 with a tea addition workstation 114, a milk addition zone 105 with a milk addition workstation 115, a sealing zone 106 with a sealing workstation 116, and a cup output zone 107 with an output workstation 117 at which a cup is shaken before output.

When an order message (a cup of half-sugar & less-ice milk tea) is received by the server appliance 3, the self-propelled vehicle device 2 is enabled by the server appliance 3 and runs by following a trajectory line object 13. Then, information for a position of the self-propelled vehicle device 2 approaching a location at which a trajectory is interrupted and stopping is passed from distinct sensor elements 12. Further, the server appliance 3 enables the ice addition workstation 112 according to the order message for addition of ice into the beverage cup 5; after ice is added into the beverage cup 5, the self-propelled vehicle device 2 resumes a forward movement.

Gradually, the self-propelled vehicle device 2 passes through all workstations 112, 113, 114, 115, 116, the sensor elements 12 and the output workstation 117 for output of a beverage product 6 from the cup holder 26. In addition to a trajectory interruptible in design, a sensor element 12 can be deigned on the trajectory line object 13 directly (as shown in FIG. 6C) such that the self-propelled vehicle device 2 can stop without an interruptible trajectory in design. In this situation, when the sensor element 12 is detected by the self-propelled vehicle device 2, the server appliance 3 depends on a series number of the self-propelled vehicle device 2 transmitted from different sensor elements 12 to determine a current position of the self-propelled vehicle device 2 and control a moving direction of the self-propelled vehicle device 2.

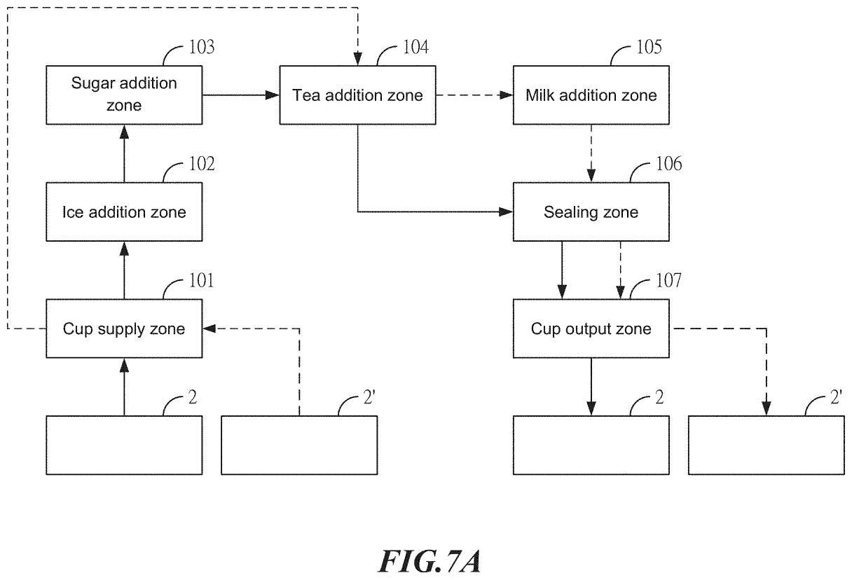

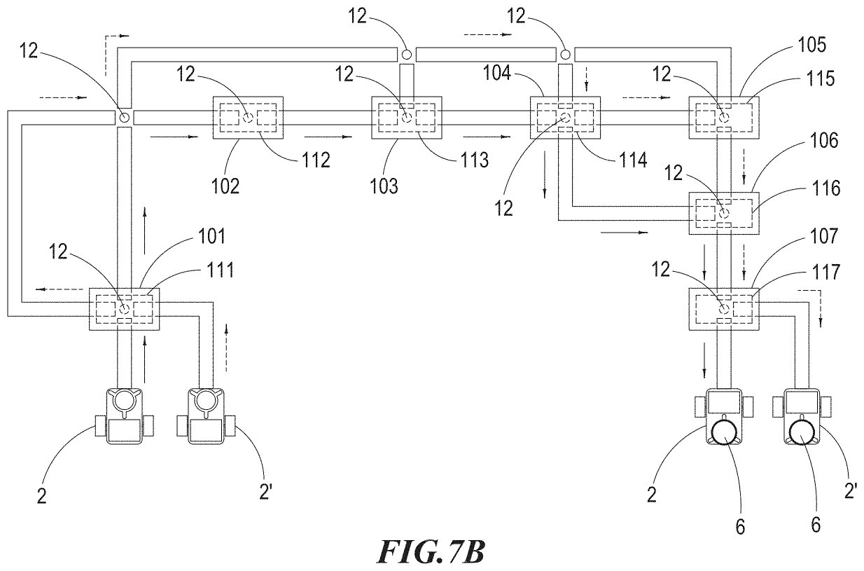

As shown in FIGS. 7A and 7B for another embodiment, two self-propelled vehicle devices 2, 2′ are deployed for two order messages and different move paths:
(1) Order message A, a cup of half-sugar & less-ice oolong tea produced by the self-propelled vehicle device 2: the self-propelled vehicle device 2 moves and arrives at the cup supply workstation 111; the empty beverage cup 5 is loaded onto the self-propelled vehicle device 2 at the cup supply workstation 111; the self-propelled vehicle device 2 further moves and stops at the ice addition workstation 112, the sugar addition workstation 113 and the tea addition workstation 114 sequentially and makes a turn to arrive at the sealing workstation 116 at which the beverage cup 5 is sealed; the self-propelled vehicle device 2 passes through the output workstation 117 for output of a beverage product 6.
(2) Order message B, a cup of sugar-free & ice-free milk tea produced by the self-propelled vehicle device 2′: the self-propelled vehicle device 2′ moves and arrives at the cup supply workstation 111; the empty beverage cup 5 is loaded onto the self-propelled vehicle device 2′ at the cup supply workstation 111; the self-propelled vehicle device 2 further moves and stops at the tea addition workstation 114 and the milk addition workstation 115 sequentially and makes a turn to arrive at the sealing workstation 116 at which the beverage cup 5 is sealed; the self-propelled vehicle device 2′ passes through the output workstation 117 for output of a beverage product 6.

In contrast to other designs in the prior art, a beverage self-propelling and production system in the present disclosure features advantages as follows:
(1) A self-propelled vehicle device in a beverage self-propelling and production system is flexibly applicable to individual beverage orders for changeable ingredients to be fed and runs along distinct move paths for probability of multiple beverage productions and effective applications short in the prior art.
(2) A self-propelled vehicle device in a beverage self-propelling and production system matches different beverage production workstations in applications, dispenses with the design of a large-scale robot & track system developed for synthesized output of several cups of beverages, and saves costs of system design.

A beverage self-propelling and production system has been disclosed in preferred embodiments hereof which is not taken as examples to restrict the scope of the present application. Any change and/or modification made by the skilled persons who have general knowledge in the art and familiarize themselves with the above technical features and embodiments without departing from the spirit and scope of the present disclosure should be covered in claims of the patent specification.

What is claimed is:

1. A beverage self-propelling and production system, comprising:
a beverage production region with several beverage production workstations and several trajectory line objects wherein the trajectory line objects are arranged among the different beverage production workstations in which several move paths are created;
a self-propelled vehicle device equipped with one or more cup holders, each of which carries a beverage cup thereon, and moving along the trajectory line objects;
a server appliance communicating with several beverage production workstations as well as the self-propelled vehicle device and producing and sending one or more instructions through which a move path of the self-propelled vehicle device is controlled and the beverage production workstations are operated for production and output of a beverage product after completion of the self-propelled vehicle device passing through different beverage production workstations in turn.

2. The beverage self-propelling and production system as claimed in claim 1 wherein each of the beverage production workstations is provided with an ingredient output appliance with which at least an ingredient, for example, ice, sugar, tea, milk or a combination thereof, is added into a beverage cup.

3. The beverage self-propelling and production system as claimed in claim 1 wherein each of the beverage production workstations comprises an appliance listed as follows:
a positioner appliance with which a beverage cup is placed on a cup holder;
a sealing appliance with which a beverage cup is sealed; or
a shaker appliance with which a beverage product is shaken.

4. The beverage self-propelling and production system as claimed in claim 1 wherein the beverage production region is provided with several sensor elements, each of which is installed on a beverage production workstation, on a trajectory line object, and/or between different trajectory line objects, interacts with the self-propelled vehicle device for mutual induction, and passes a position signal as well as a series number of the self-propelled vehicle device to the server appliance such that a current position of the self-propelled vehicle device is determined by the server appliance according to the series number transmitted from different sensor elements.

5. The beverage self-propelling and production system as claimed in claim 4 wherein the sensor elements are operated based on the near field communications technology or the radio frequency identification technology.

6. The beverage self-propelling and production system as claimed in claim 4 wherein the self-propelled vehicle device comprises a vehicle body, a printed circuit board installed on the vehicle body and a power supply unit: the vehicle body is provided with at least a wheel installed at each of both sides and electrically connected with a motor element by which the wheel is driven to rotate; the vehicle body is equipped with at least a supporting roller ball component at the bottom.

7. The beverage self-propelling and production system as claimed in claim 6 wherein the printed circuit board is equipped with:
a central controller;
a power drive circuit component, which is electrically connected with the central controller and the motor element for driving the motor element;
a wireless communications circuit component, which is electrically connected with the central controller and used to receive a trajectory motion instruction from the server appliance and control a move path of the vehicle body based on the trajectory motion instruction;
a sensor circuit component, which is electrically connected with the central controller and used to detect the sensor element and send a series number of the self-propelled vehicle device to the detected sensor element from which the series number is transferred to the server appliance such that a current position of the self-propelled vehicle device is determined by the server appliance according to the series number transmitted by different sensor elements;
a tracking circuit component, which is electrically connected with the central controller and used to emit a tracking signal that may contact a plane for reflection of an optical signal wherein the tracking circuit component depends on intensity of the reflected optical signal to correct a move path of the vehicle body.

8. The beverage self-propelling and production system as claimed in claim 7 wherein the cup holder further comprises a weight detection circuit component which is electrically connected with the central controller and used to detect the weight of a beverage cup and pass a signal for the detected weight to the server appliance through the wireless communications circuit component such that a beverage production workstation is operated by the server appliance controllably based on the received signal for the detected weight.

9. The beverage self-propelling and production system as claimed in claim 7 wherein the power supply unit further comprises a power detection circuit component which is electrically connected with the central controller and used to detect power of the power supply unit and pass a signal for the detected power to the server appliance through the wireless communications circuit component.

10. The beverage self-propelling and production system as claimed in claim 7 wherein the server appliance is equipped with a central control circuit component, a wireless transmission circuit component and an inductive receiver circuit component inside wherein the central control circuit component that is connected with the wireless transmission circuit component and the inductive receiver circuit component is able to navigate the self-propelled vehicle device to change a move path according to at least a group of order messages.

11. The beverage self-propelling and production system as claimed in claim 10 wherein the central control circuit component of the server appliance produces and transmits one or more station execution instructions with which a beverage production workstation is operated controllably.

12. The beverage self-propelling and production system as claimed in claim 10 wherein the server appliance further links a POS machine from which at least a group of order messages are created.
